(19) United States
(12) Patent Application Publication
(10) Pub. No.: US 2014/0318478 A1
(43) Pub. Date: Oct. 30, 2014

(54) PROTECTIVE ANIMAL GARMENT

(71) Applicant: Enrique Cruz, Lantana, FL (US)

(72) Inventor: Enrique Cruz, Lantana, FL (US)

(21) Appl. No.: 14/265,310

(22) Filed: Apr. 29, 2014

Related U.S. Application Data
(60) Provisional application No. 61/816,869, filed on Apr. 29, 2013.

(51) Int. Cl. A01K 13/00

(52) U.S. Cl. CPC A01K 13/006
USPC 119/850

(57) ABSTRACT

An animal protective garment includes a body, legs and integral boots. The legs may include openings covered by flaps. The openings provide access to the interior of the garment so that a person may properly position an animal's foot or paw within integral boots. The garment may include a lining for comfort and patches of durable material. The integral boots may also include durable soles.

### CROSS-REFERENCE TO RELATED APPLICATIONS

This application claims priority to U.S. Provisional Application Ser. No. 61/816,869, filed Apr. 29, 2013, the contents of which are hereby incorporated by reference.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX:

Not Applicable.

### BACKGROUND OF THE INVENTION

1. Field of Endeavor

The present invention relates to an apparatus for protecting animals. More particularly, the invention relates to a protective garment for use with domesticated animals to prevent abrasions, cuts, wounds and other maladies.

2. Background Information

Cats and dogs encounter a variety of dangers in their day to day lives. Pets may be vulnerable to attacks from other animals, broken glass and other sharp household objects, and much more. Additionally, animals tend to scratch and otherwise damage floors, furniture, curtains, and other household items and surfaces.

Articles for use in protecting animals from physical harm and insulating them from harsh environments have been around as long as animals have been held as domestic pets and as valuable undomesticated animals. With the increased domestication and integration into family life of household pets, it has become increasingly popular to include pets in all family events, and increased use in harsh conditions. Animals are exposed to environments that are a typical to their breed or vary from their day-to-day lives. It is also increasingly popular to afford domestic pets human luxuries such as fashionable outerwear.

Dogs have long been known as “man's best friend”. These animals serve very diverse functions, providing companionship, guarding, towing, hunting, and even sensory conversion, such as a seeing eye-dog, a hearing-assist dog, and even a police or military dog. Regardless of the relationship between person and dog, at various times, and for many diverse reasons, it may be highly desirable for the dog owner to place boots upon the dog's paws. For example, in inclement weather, a person may not wish to try to clean a dog's paws after the dog has been outside. Boots that may be placed and then readily removed may be much easier to use than what might be required to thoroughly clean the dog's feet. In other instances, a dog may have injured one or more paws, and so may not have the usual toughness. In such case, a suitable boot may help to protect the affected paw until sufficient healing has occurred to no longer require the boot. In other cases, the dog's pads may be inadequate for traversing the ground when temperatures are particularly severe, such as in colder climates or with dogs that are not adapted to the cold, or conversely in extremely hot climates where the ground surface may be scorching. Racing and sled dogs may be exposed to a particularly harsh course or environment, and so may also need special protection. Boots can be used to prevent snow from getting up between the pads of the foot, freezing, abrading the soft tissue, and thereby producing a lame dog.

Prior art garments that protect common household pets, for example, dogs, during field exercises or hunting conditions, include complex shapes and pads having multiple pieces that need to be secured together on the animal and, depending on the level of protection required, are bulky and cumbersome.

Prior art garments with insulating properties further comprise multiple pieces requiring at least partial assembly on the animal. Such devices incorporate numerous points of attachment around the animal, requiring difficult movements by the user, such as bending and kneeling down for an extended period, to position the garment on the animal and then secure it. The highly active nature of animals, particularly canine puppies and young dogs, renders the difficult and complex installation of such garments even more trying.

Prior art designs due to the complex, multi-piece design and attachment schemes noted above, further make the garment expensive, difficult to manufacture and more importantly, difficult to install and use both for the user and the animal.

Consequently, it would be desirable to provide an animal coat improving on the problematic conditions in the prior art and to provide a coat which is inexpensive, facilitates manufacturing and assembly, and is easy to secure, use and remove while affording substantial protection to the animal from harsh environments.

When a dog is used in the field for activities such as hunting and retrieving, the feet and legs of the animal are susceptible to a number of hazards. Harsh terrain, and thorns and burrs can lead to painful, sore paws, and running through underbrush can often subject the animal's legs to scraping, cuts, and abrasion. Additional hazards confront the dog when he hunts in cold weather, and in wet conditions where exposure of the dog's feet and legs can lead to discomfort stiffening of the joints, and excessive chilling. Dogs that are kept primarily as domestic pets for most of the year are particularly susceptible to such injury and harm in the field. Prior devices are quite limited in their ability to protect the leg, including joints, from physical abrasion as well as the cold and wet environment.

The prior art shows a variety of devices for protecting the feet and legs of animals such as dogs. Examples are shown in U.S. Pat. Nos. 4,457,261, 4,458,431, 2,651,853, and 2,535,394. Unfortunately, while these prior art boots, and such devices as are currently available, may prove useful in protecting one's pet during casual dog-walking activities, such as along sidewalks, and through parks, they lack in meeting the more stringent requirements of the hunting dog.

A number of artisans have recognized one or more of the foregoing needs, and so have designed various dog boots. However, these prior art boots tend to suffer from several common limitations. As may be recognized, prior art dog boots are often very difficult to put on the dog's foot. This problem will be intensified by the fact that most dogs will not remain still while a person is trying to put the boot on. Once on, these prior art boots do not stay on well. Many will simply spin about, potentially causing much discomfort or harm to the dog. Others will slide off as the dog walks or runs, much like loose socks coming off of a person walking on carpet. This phenomenon is quite significant, since the boot must be designed to be of non-slip material, or the dog will sprawl on finished wood, icy or other relatively slippery surfaces. Yet, the boot must also preferentially stay on the dog's paw, rather than slide with respect thereto, even when the booted dog is traversing terrain having good traction. Simply applying more force about the dog's leg to keep the boot on has proven to be totally unsatisfactory, since circulation within the leg may become limited or disrupted. Unintended bunching of the boot top can be harder to detect, and can also restrict circulation.

In view of the foregoing, there is a need for a protective garment for dogs and other animals that protects the entire animal. It is therefore desirable to provide a protective garment that overcomes deficiencies found in the prior art.

### BRIEF SUMMARY OF THE INVENTION

Accordingly, the primary object of the present invention is to provide a protective garment for animals.

In greater detail, it is an object of the invention to provide a garment that adequately protects an animal while also securing its feet or paws securely within a boot such that the boot does not get twisted about, and so that the paw does not inadvertently become improperly positioned within the boot.

It is therefore an object of the present invention to provide protection for an animal from injuries caused by sharp objects, another animal's claws or teeth, and other common hazards.

It is another object of the invention to provide a pet protection from harm when riding in a vehicle and keeps the inside surfaces of a vehicle free from pet hair and claw marks.

It is another object of the invention to provide a comfortable design that does not restrict the animal's movement.

It is another object of the invention to utilize a durable design that can be worn indoors and outdoors at all times.

It is another object of the invention to provide to guard furniture, floors, and other delicate surfaces against a pet's sharp claws.

These and other objects and advantages of the present invention will become apparent from a reading of the attached specification and appended claims. There has thus been outlined, rather broadly, the more important features of the invention in order that the detailed description thereof that follows may be better understood, and in order that the present contribution to the art may be better appreciated. There are features of the invention that will be described hereinafter and which will form the subject matter of the claims appended hereto.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is a side view of a protective animal garment in accordance with the principles of the invention;

FIG. 2 is a front view of a leg of the garment of FIG. 1 with an open flap in accordance with the principles of the invention;

FIG. 3 is a front view of a leg of the garment in FIG. 1 with a closed flap in accordance with the principles of the invention;

FIG. 4 is a side view of a leg of the garment in FIG. 1 in accordance with the principles of the invention;

FIG. 5 is a side view of an alternative embodiment of a protective animal garment in accordance with the principles of the invention;

FIG. 6 is an enlarged view of a leg of an alternative embodiment of a protective pet garment in accordance with the principles of the invention;

FIG. 7 is a perspective view of an alternative embodiment of a protective pet garment in accordance with the principles of the invention.

### DETAILED DESCRIPTION

Before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

Disclosed is a comfortable, full-body protective suit for animals that can be worn both indoors and outdoors to shield a household pet against the general perils of day-to-day life without restricting its range of motion. A garment in accordance with the principles of the invention may comprise a garment that covers an animal from the neck down, including the paws. There may be a long zipper down the back to provide access when fitting the garment onto a pet or removing it. The device may be constructed from soft fabric with rubber soles and claws, and may have patches of Poly-paraphenylene terephthalamide or another puncture-resistant material covering the animal's joints and other vulnerable places. These patches may cover hip and shoulder joints, spots on the animal's legs that may rub the ground while the animal is lying down, parts of the abdominal region, parts of the back and sides, and more. The rubber foot coverings can provide traction and protection against puncture wounds, and can be attached to the rest of the suit by means of a breathable material. The invention may come in a wide variety of sizes to suit all cats and dogs, and may come in anatomically correct designs for pets of each sex. The exact specifications may vary.

In greater detail, Disclosed is a protective garment for a pet, such as for example a dog, cat or other animal. While the examples provided below generally describe a garment in relation to a dog, it will be appreciated that the invention may be utilized to provide protective covering for a variety of animals. Such a garment may be used to protect both the animal as well as its environment. For example, it may be desirable to avoid direct contact between the pet and car seats, sofas, recliner chairs, beds, bed covers, curtains, finished wood furniture or the like. This may prevent a pet or other animal from scraping, damaging, soiling, depositing hair or dander on or spreading germs to these items.

The garment may be comprised of one or more layers. For example, it may be desirable to have an outer layer made of a heavy, thick or rough material. The garment may have an inner lining made of a soft material, such as cotton, rayon, silk, linen or other material. It may be desirable to include patches of durable material at various locations on the outside of the garment. For example, it may be desirable to provide extra padding or covering at joints such as knees and shoulders and/or on the bottom of the feet.

The garment may cover most or all of an animal's body. It may be desirable to leave an opening near the back so that the animal may relieve itself and/or to allow the tail to move freely. The zipper may run along the spine of the garment and allow the garment to be opened so that an animal may be inserted into it. It may optionally be desirable for the garment to completely cover an animal. In that situation, it may be desirable for an animal to wear a diaper or similar device so as not to soil the inside of the garment. The garment may be made of breathable material or may be partially or completely watertight and/or airtight.

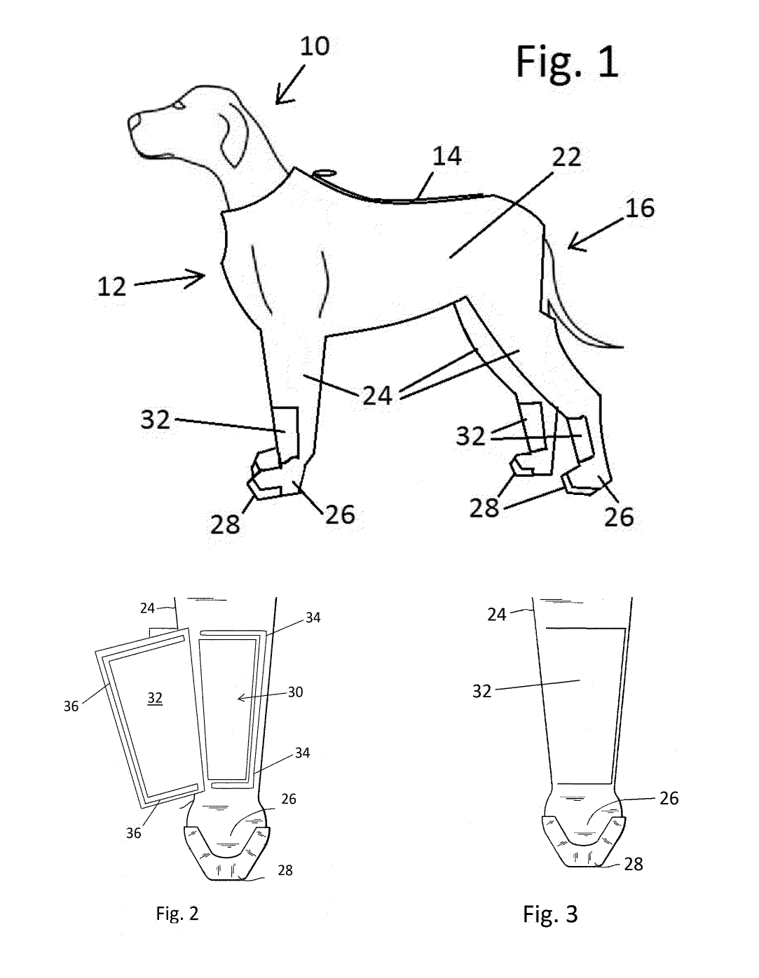

FIG. 1 shows a dog 10 wearing a garment 12 in accordance with the principles of the invention. The garment may include an entrance point 14 having a zipper that may be unzipped to open the garment so that a animal 10 may be placed inside it. It may be desirable to have a single entrance point along the spine, as shown here, or it may be desirable to locate one or more openings and/or entrance points elsewhere in addition to or in place of the entrance point 14 shown here. Similarly, it may be desirable to use a tongue and groove sealing mechanism, buttons, snaps or other sealing means to enclose the animal 80 in the garment 12.

In this embodiment, the garment 12 includes an rear opening 16 that allows the tail to protrude from the garment. The rear opening 16 may optionally also expose the animals hindquarters such that the animal may urinate and defecate without soiling the garment 12. The garment 12 may include a body region 22 and 4 legs 24. The garment 12 may also include integral boots 26 at the bottom of each of the legs 24. Integral boots 26 are designed to conform to the size and shape of the paws of the dog 10 such that the paws do not accidentally slide up into the leg portion 24 of the garment 12. As used herein, the term “integral boot” generally refers to a boot, or paw covering device, that is fixedly attached to or integral with the leg of the garment such that it may not be separated from the garment, similar to “footsie” pajamas popular among children.

Integral boots 26 may each have a reinforced sole 28. Reinforced sole 28 may be comprised of rubber, plastic, carbon fiber, kevlar or any other material. It may be desirable to ensure that the animal's paws 10 remain positioned and oriented correctly within each of the boots 26 so that the pet trods upon the soles 28 of the boots 26.

FIG. 2 shows the front portion of one of the legs 24 of the garment 12. Each of the legs 24 may include a positioning access opening 30 and a flap 32. Velcro strips 34 and 36 may adhere to one another to hold flap 32 firmly and securely over positioning access opening 30. When the garment 12 is placed about a pet dog 10, flap 32 may be pulled open to expose positioning access opening 30. This positioning access opening 30 may allow a person placing the garment 12 on the dog 10 to access the paws of the dog 10 and properly orient the paws within the boot 26. Flap 32 may then be closed over positioning access opening 30 to fully enclose the garment. In this particular embodiment, Velcro strips 34 and 36 are used to secure the flap 32 over opening 30. However, other mechanisms may be employed, such as for example a zipper, a tongue and groove mechanism, snaps, buttons, laces or a combination of devices. It may be desirable to utilize a mechanism that provides watertight and/or airtight sealing of opening 30. The positioning access openings may generally be located just above the boot, near the bottom of the legs, and are preferably located at the front of the legs, but may optionally be located on the sides or rear of the legs of the garment.

FIG. 3 shows the front of a leg 24 with the flap covering positioning access opening 30. In this position, flap 32 covers positioning access opening 30 such that the animal 10 is not exposed. If flap 32 is secured using a watertight or airtight mechanism, then the dog may walk through many different types of environments without injury and without becoming dirty.

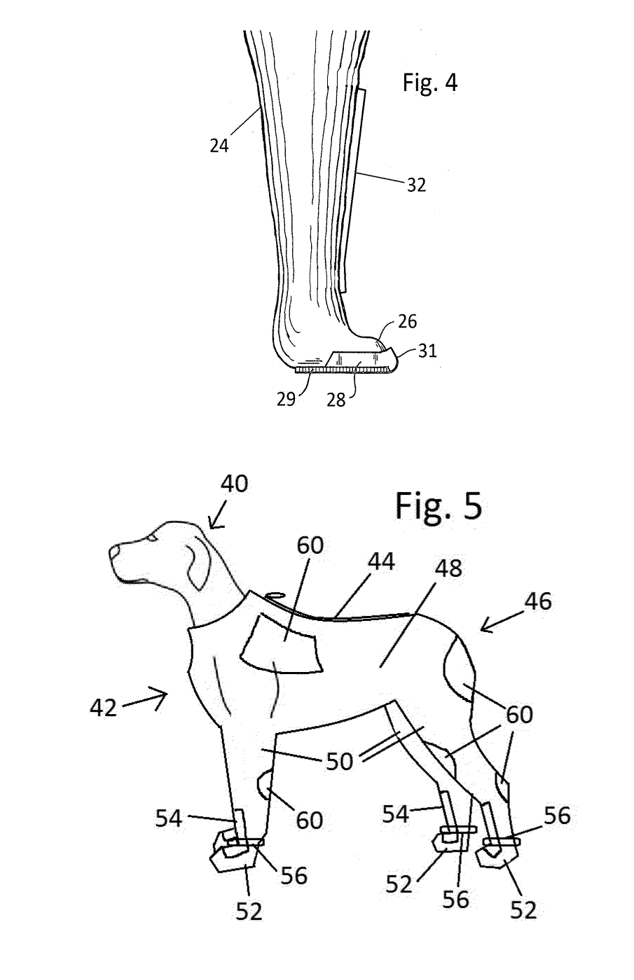

FIG. 4 shows a side view of the leg 24 with the flap 32 closed over positioning access opening 30. FIG. 4 also shows the sole 28 in more detail. Sole 28 may include a rigid and/or durable front and side wall 31 and a textured bottom 29. The rigid side wall 31 may extends across the front of the boot 26 and extends about the sides. This may prevent an animal from accidentally stubbing 80 or otherwise injuring its path. Textured bottom surface 29 may provide improved traction while the animal is walking.

In another further embodiment, shown in FIG. 5, a dog 40 is inside a garment 42. Garment 42 may include an entrance point 44, in this embodiment having a zipper, to provide access to the inside of the garment so that the dog 40 may be placed therein. Other opening and closing devices, such as for example, buttons, snaps, laces, a tongue and groove mechanism, or combinations thereof, may also be used. It may be desirable for the opening to be airtight and/or watertight and it may be desirable to use other mechanisms in addition to a zipper. Hind region 46 may be completely sealed and not include an opening. This may be desirable when an animal may be exposed to harsh conditions or to water. Garment 42 includes a body region 48 and 4 legs 50 each of the 4 legs 50 include an integral boots 52 and flaps 54 may allow access to positioning access openings that may allow a person to properly position the dogs paw within the boots 52. In this embodiment, adjustable straps 56 may be loosened when opening flaps 54 and tightened around the ankle regions of the legs to secure the paws within boots 52.

Garment 42 may also include one or more reinforcing patches 60 to provide added protection. Reinforcing patches 60 may be positioned in various locations, such as joints, that may be impinged on by a variety of things. In addition, it may be desirable to utilize Kevlar for some patches or for the entire garment. Kevlar may make the garment bullet proof and may provide extra protection in difficult environments.

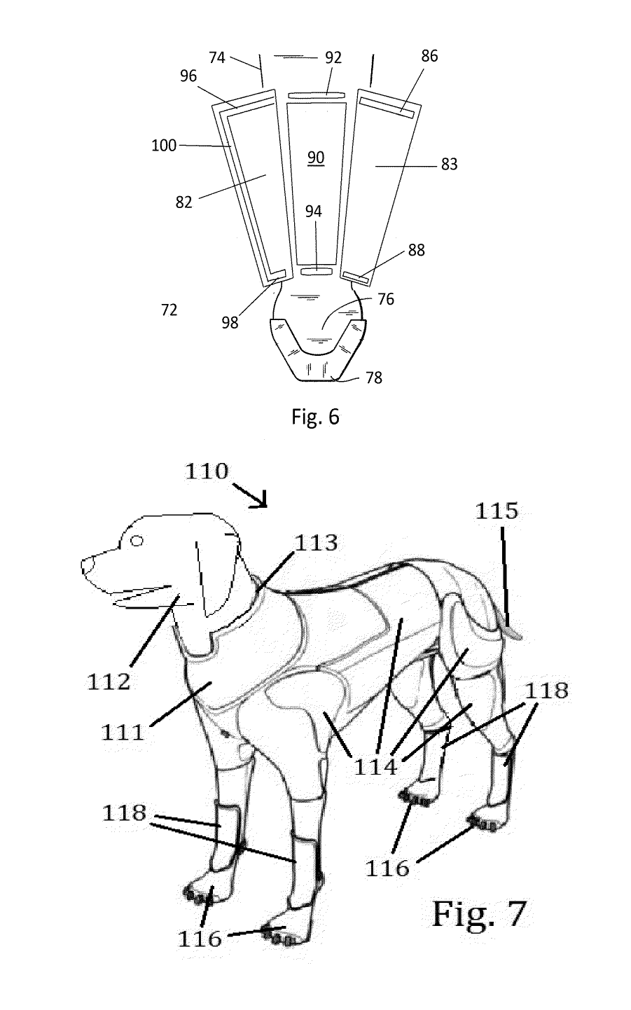

In another embodiment, FIG. 6 shows a front positioning access opening 90 of a front portion of one of the legs 74 of the garment 72. Each of the legs 74 may include a positioning access opening 90, a flap 82 and a flap 83. Velcro strips 92 and 94 are located above and below the opening 90. Velcro strips 86 and 88 of flap 83 may adhere to velcro strips 92 and 94, respectively. Similarly, velcro straps 96 and 98 of flap 82 may adhere to velcro strips 92 and 94 respectively. Velcro strip 100 of flap 82 may adhere to a corresponding velcro strip on the exterior of flap 83, not shown.

When the garment 72 is placed about a pet, flaps 82 and 83 may be pulled apart to expose opening 90. This opening 90 may allow a person to access the paws of a pet and properly orient the paws within the boot 76. Flap 83 may then be closed over opening 90 and flap 82 closed over the opening 90 such that strip 100 engages a corresponding strip on the outside of flap 83 to fully enclose the opening 90. In this embodiment, Velcro strips are used to secure the flaps 82 and 83 over opening 90. However, other mechanisms may be employed, such as for example a zipper, a tongue and groove mechanism, snaps, buttons, laces or a combination of devices. It may be desirable to utilize a mechanism that provides watertight and/or airtight sealing of opening 90.

FIG. 7 shows an alternative embodiment of a protective pet garment 110. Protective pet garment 110 is comprised of a body 111 formed from a flexible fabric. The body 111 may optionally include a lining on the inside to provide comfort. Body 111 may be comprised of a fabric that breathes. The body 111 may optionally include one or more protective patches 114 that may be comprised of a heavier material, for example Kevlar. Optionally, protective patches 114 may be comprised of particularly durable material such as high-density plastic, or even ceramic or a metal alloy.

A pet, 112, in this embodiment, a dog, may be substantially covered by the protective pet garment. A neck opening 113 allows the pet head to protrude outward from the garment 110. Another opening, not shown, allows the pet tale 115 to protrude from the rear of the garment 110. The garment 110 may optionally include other holes that provide for ventilation or other purposes.

As with the other embodiments, protective pet garment 110 includes boots 116 that may protect a pet's paws. Similarly, flaps 118, may be removed or pulled aside in order to adjust the pet 112's paws when the suit is put on. This may prevent the paws from being tangled or other difficulties when inserting the pet 112 into the garment 110. Flaps 118, may be attached to the garment 110 by any suitable mechanism, as shown in other embodiments, or otherwise. It may be desirable for the garment to be watertight, or heat resistant. Optionally, it may be desirable for the garment to have vents to allow airflow to prevent overheating of the animal.

Whereas, the present invention has been described in relation to the drawings attached hereto, it should be understood that other and further modifications, apart from those shown or suggested herein, may be made within the spirit and scope of this invention. Descriptions of the embodiments shown in the drawings should not be construed as limiting or defining the ordinary and plain meanings of the terms of the claims unless such is explicitly indicated.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

1. An animal garment comprising:
a body region;
an entrance point on the body region; and,
four legs, each having an integral boot and a positioning access opening;
wherein the positioning access openings allow a person to properly position an animal's paws within the integral boots.

2. The animal garment of claim 1 wherein the entrance point and the positioning access openings are capable of being sealed such that they are watertight

3. The animal garment of claim 1 further comprising flaps over the positioning access point.

4. The animal garment of claim 1 further comprising a rear opening.

5. The animal garment of claim 1 wherein the integral boots have reinforced soles.

6. The animal garment of claim 1 further comprising reinforced patches on the exterior of the garment.

7. The animal garment of claim 6 wherein the reinforced patches are comprised of kevlar.

8. The animal garment of claim 1 further comprising a lining inside the garment.

9. The animal garment of claim 1 wherein the garment is watertight.

10. The animal garment of claim 1 wherein the body region includes vents to allow airflow through the garment.

11. The animal garment of claim 1 wherein each leg further comprises an adjustable strap at the ankle.

12. An animal garment comprising:
a body region;
an entrance point on the body region;
a rear opening; and,
four legs, each having an integral boot and a positioning access opening;
wherein the positioning access openings allow a person to properly position an animal's paws within the integral boots.

13. The animal garment of claim 12 further comprising flaps over the positioning access points.

14. The animal garment of claim 12 wherein the entrance point and the positioning access openings are capable of being sealed such that they are watertight

15. The animal garment of claim 14 wherein the integral boots have reinforced soles.

16. The animal garment of claim 15 further comprising reinforced patches on the exterior of the garment.

17. The animal garment of claim 16 wherein the reinforced patches are comprised of kevlar.

18. The animal garment of claim 17 further comprising a lining inside the garment.

19. An animal garment comprising:
a body region having an interior lining and exterior reinforced patches;
an entrance point on the body region;
a rear opening; and,
four legs, each having an integral boot with a reinforced sole, a positioning access opening, flaps over the positioning access opening and adjustable straps at the ankle straps;
wherein the positioning access openings allow a person to properly position an animal's paws within the integral boots.

20. The animal garment of claim 19 wherein the positioning access points are capable of being sealed such that they are watertight.
